(19) United States
(12) Patent Application Publication
(10) Pub. No.: US 2018/0221975 A1
(43) Pub. Date: Aug. 9, 2018

(54) CIRCULAR SAW BLADE ASSEMBLIES

(71) Applicant: THOMAS J. RUZICH, BAKER CITY, OR (US)

(72) Inventor: THOMAS J. RUZICH, BAKER CITY, OR (US)

(21) Appl. No.: 15/947,367

(22) Filed: Apr. 6, 2018

Related U.S. Application Data
(63) Continuation of application No. 14/577,555, filed on Dec. 19, 2014, now abandoned.

(51) Int. Cl. B23D 61/02; B28D 1/12; B23D 61/06

(52) U.S. Cl. CPC B23D 61/025; B28D 1/124; B23D 61/06; B28D 1/122

(57) ABSTRACT

What is disclosed is a blade core for attachment with an endless chain assembly. The blade core is a generally circular disc having two opposing faces and a width between the faces. The blade core has a circumferential groove extending inward from the circumference of the blade core such that the drive links, or the tang of the drive links, extends from the chain located on the circumference of the circular disc inward in said groove. Ideally the width of the groove is proximate to the width of the drive link such that friction between the sides of the groove and the drive link prevent the chain from rotating along the circumference of the circular disc when the blade core and endless chain assembly are rotating to cut a material. Ideally the base of tie-strap-tie strap and tie strap-cutter assembly is the same as width of the rail to restrict lateral movement.

### CROSS-REFERENCE TO RELATED APPLICATIONS

This application is a continuation of U.S. patent application Ser. No. 14/577,555, filed Dec. 19, 2014, the disclosure of which is incorporated by reference.

### TECHNICAL FIELD

The presently disclosed and claimed inventive concept(s) generally relates to circular saw blade assemblies, and more particularly to improve circular saw blade assemblies for cutting various hard materials such as building materials, and utilizing a chain with cutting portions positioned on the blade core such that a cutting tip section can be replaced by replacing the chain or sections of the chain.

### BACKGROUND

Generally in the field of circular cutting saws, blades, and blade assemblies, the tooling utilizes a circular blade core, the circumference of which is configured with a cutting section. Generally, the circumference has individual cutting elements attached to the blade, specifically to the blade core. These blade cores, when used with a rotary saw, spin at very high speeds cutting material in the path of the blade. The cutting elements have relatively high deterioration rates due to abrasion and impacts from the cutting. This abrasion is caused by wear due to the impacts from hitting hard objects that lead to a large amount of frictional heat generated as well as abrasive contact with the saw blades.

In general, circular saw blade assemblies are made in two different embodiments. In a first general embodiment, the circular saw blade assemblies comprise a core having cutting segments affixed to the core, typically by welding, soldering, braising, electroplating, or bolting. Alternatively, as shown in U.S. Pat. No. 4,627,322, the contents of which are hereby incorporated by reference, it has been contemplated to use replaceable chains, such as cutters attached to removable chains such as chains found on a chainsaw, on the exterior of the core to form the cutting element. In this embodiment it is thought that in the event that the cutting tips of the saw become dull or damaged, the chain can be removed and the chain links containing the cutting tips can be replaced or new cutting tips placed on the chain. While the chain is being repaired, a second chain can be used in the meantime on the original core, thus avoiding the need for a new blade core to be used each time the cutting elements must be replaced or repaired (such as when the tips must be sharpened).

### SUMMARY OF THE DISCLOSURE

Accordingly, what has been developed is a blade core having a circumferential groove for chain drive links. A cutting chain is then placed on the core by stretching the chain.

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

For the purposes of this application, the term drive link means the general shape of a standard drive link of a chain as depicted, for example, in FIG. 1, reference number 14, and FIGS. 4, reference number 58, and FIG. 5, reference number 70, of published application U.S. 2014/0298963. The terms “circular saw” and “rotary saw” are used herein interchangeably.

The term “circular saw blade” is referred to as a blade core having a chain configured on the blade core such that the drive links of the chain are located within the circumferential groove located on the blade core.

What is disclosed in a preferred embodiment is a circular core for a saw blade for use with a chain. The circular core has a circular disc like core body having an outer circumference and a width. The core body has a central arbor substantially at the center of said core body and configured to provide an axis of rotation for when the core body is attached to a circular saw. The core body has a first side and a second side and a width between the first side and the second side. The core body has a circumferential groove extending inward from the circumference of the core body and is located between the first side and said second side and ends at a groove floor. In a preferred embodiment, the core body has an endless chain positioned on the circumference of the core body such that the drive links (or protrusions of the drive links interchangeably called drive link tangs) of the chain are positioned within the circumferential groove.

In a preferred embodiment the width of the circumferential groove is approximate to the width of said drive links positioned within said circumferential groove. It is thought that this creates friction between the drive link and the walls of the groove such that when the blade core and chain are driven on a circular saw, the friction between the drive link and the walls of the circumferential groove prevent the chain from spinning on the blade core when the cutting or impact surface of the chain impacts an object.

In a preferred embodiment, the width and tolerance of a circumferential groove is +0.05 mm -0. Ideally the circumferential groove is sized such that the drive link is a very tight fit with the groove such that the friction between the groove walls and the drive link hold the chain in place when the blade core and chain are spinning at very high speeds as is common in a rescue saw.

In a preferred embodiment circumferential groove and blade core are configured such that when a chain is positioned on the core, the chain is positioned such that the chain links are in contact with the circumference of the blade core when said blade core is not in use. This occurs by stretching a chain when a chain is being attached to the blade core. When tension is released from the stretched chain, the chain reflexes to be in tight contact with the blade core.

The circumferential groove in the blade core generally is made of two walls and a floor. The floor of the circumferential groove is generally located between the arbor and the outer circumference of the blade core and is between the first side and the second side of the core body. The drive links of a chain extend into the circumferential groove to a point proximate to but not in contact with the floor of the circumferential groove. It is thought that if the drive links are in contact with the floor of the groove the drive links will create stress with the floor and be prone to breakage.

In an embodiment of the invention, the circumferential groove is wider at the circumference of the circular core than at the floor of the circumferential groove. This may lead to increased friction between the groove and the drive links, or it may just be a by-product of the manufacturing process. Typically the groove does not include sprocket teeth configured for the placement within the links of a chain as found in typical saw setups in which a chain is driven around a core to cut.

One of the benefits of utilizing an endless chain on a blade core as opposed to fixed cutters on a blade core is that if the cutters are worn or break, the chain can be replaced as opposed to having to replace the entire blade core and cutters. Changing of the chain occurs, in a preferred embodiment, by removing a rivet between two tie straps of the chain to be replaced, stretching the replacement chain having two ends around the circumference of the blade core with the drive links located in the circumferential groove of the blade core, and attaching the two ends of the chain to form an endless chain around the circumference of the blade core. The tension is then released from the chain, which reflexes to a generally taught fit around the blade core. The blade core and chain assembly are then ready for use in cutting. In general, rescue saws are used to cut wood, metal, concrete and various hard materials. The embodiments of the invention(s) depicted herein are generally thought applicable in all uses in a rescue saw. This includes cutting into a building, vehicle, train, car or aircraft.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates a perspective view of a circular saw blade having cutting elements with drive links positioned in a circumferential groove on the blade core.

FIG. 2 illustrates a perspective view of a blade core of a preferred embodiment of the invention without an endless chain attached to the blade core.

FIG. 3 illustrates a first side view of a blade core and chain having a circumferential groove with chain drive links within the circumferential groove. The rails of the blade core circumferential groove are shown as transparent to illustrate the placement of the drive links of the chain within the circumferential groove.

FIG. 4 illustrates a first side view of a blade core having a circumferential groove located in the circumference of the blade core.

FIG. 5 illustrates an endless chain configured to be located in the circumferential groove of the blade core of FIG. 3.

FIG. 6 illustrates a cross sectional view of an embodiment of cutting element in relation to a circumferential groove in a blade core.

FIG. 7 illustrates a cross sectional view of an embodiment of a cutting element with a drive link within a circumferential groove of a blade core.

FIG. 8 illustrates a cross sectional view of an embodiment of a circumferential groove in a blade core in which the circumferential groove is in a tapered configuration in which the groove is wider at the circumference of the blade core than at the floor of the groove.

FIG. 9 illustrates a method of constructing an assembled cutting chain and blade apparatus according to an embodiment of the invention.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

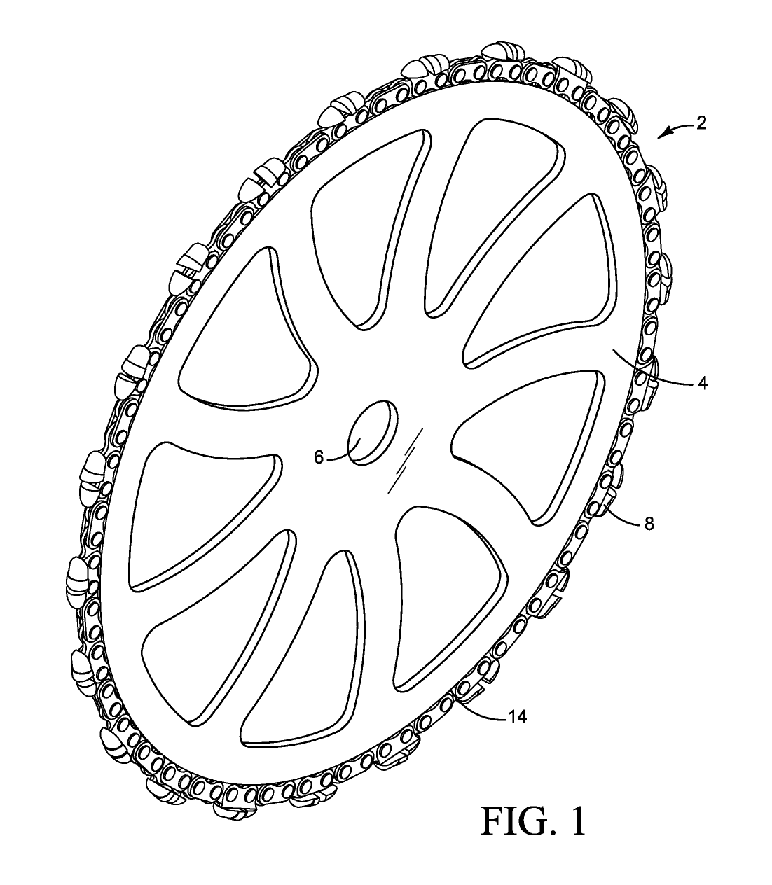

FIG. 1 illustrates a preferred embodiment of a cutting chain and blade assembly 2. The assembly has core 4 and cutting chain assembly 14 attached to the core 4. The cutting chain comprises cutters 8 that are utilized for cutting of material when the assembly is mounted on a circular saw. Arbor 6 provides an opening through which is used to attach the assembly to a circular or rotary saw. The blade core is manufactured in a preferred embodiment to ideally be utilized in rescue saws, although use in any rotary saw is contemplated by the invention.

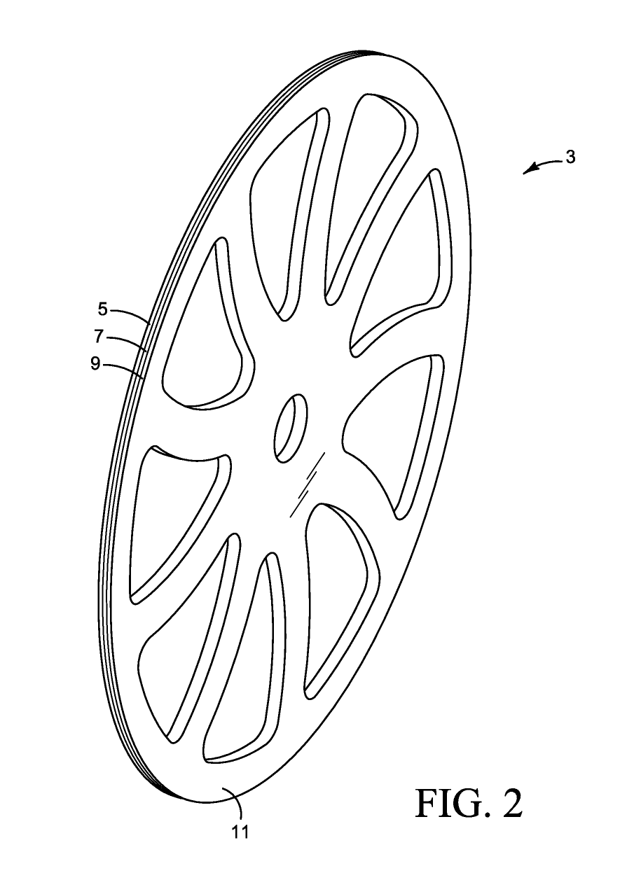

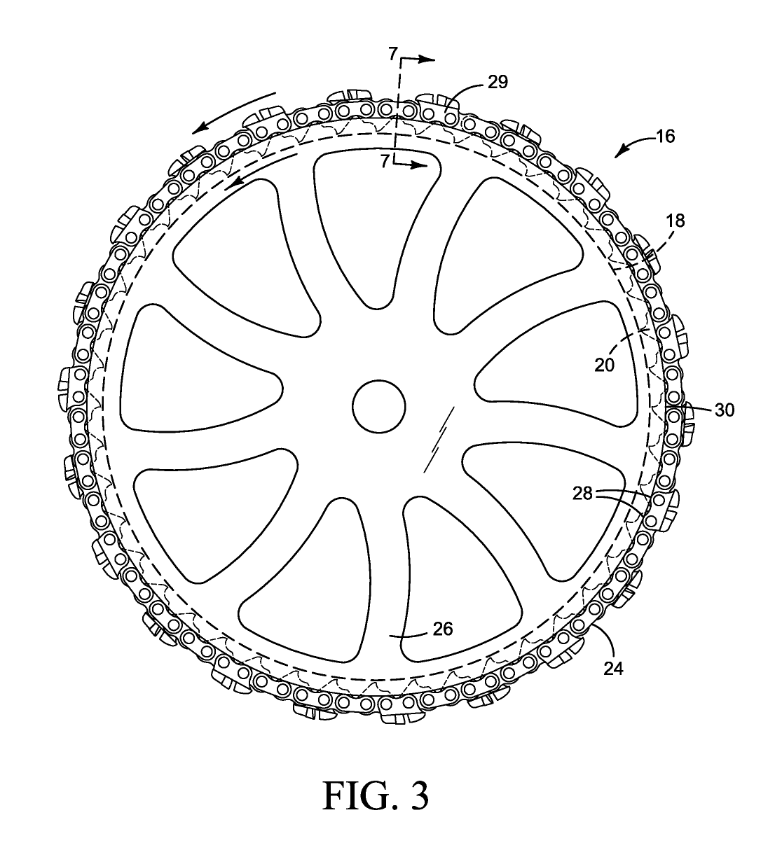

FIG. 2 illustrates a perspective view of a circular blade core 3 without an endless chain installed on the blade core to illustrate the circumferential groove in the blade core. Circumferential groove 7 is defined by rails 5, 9 in the circumference of the blade core 11. The rails in a preferred embodiment are approximately the same width as the width of a tie-strap or a cutter (reference numerals 24 and 29, respectively, of FIG. 3) in order to minimize lateral movement of the chain (and thus to decrease stress on the chain and decrease breakage of the chain) when the chain and blade assembly are utilized on a circular or rescue saw to cut an object.

FIG. 3 illustrates a blade and cutting chain assembly in which the core is shown transparently to illustrate the circumferential groove in the core. Cutting chain 24 is positioned on the core such that the drive links are within the circumferential groove 18 such that the cutting chain generally aligns with the circumference of the blade core 30. Drive links 20 project from the circumference of the blade core in the groove such that the drive links, in a preferred embodiment are not directly in contact with the floor of the groove.

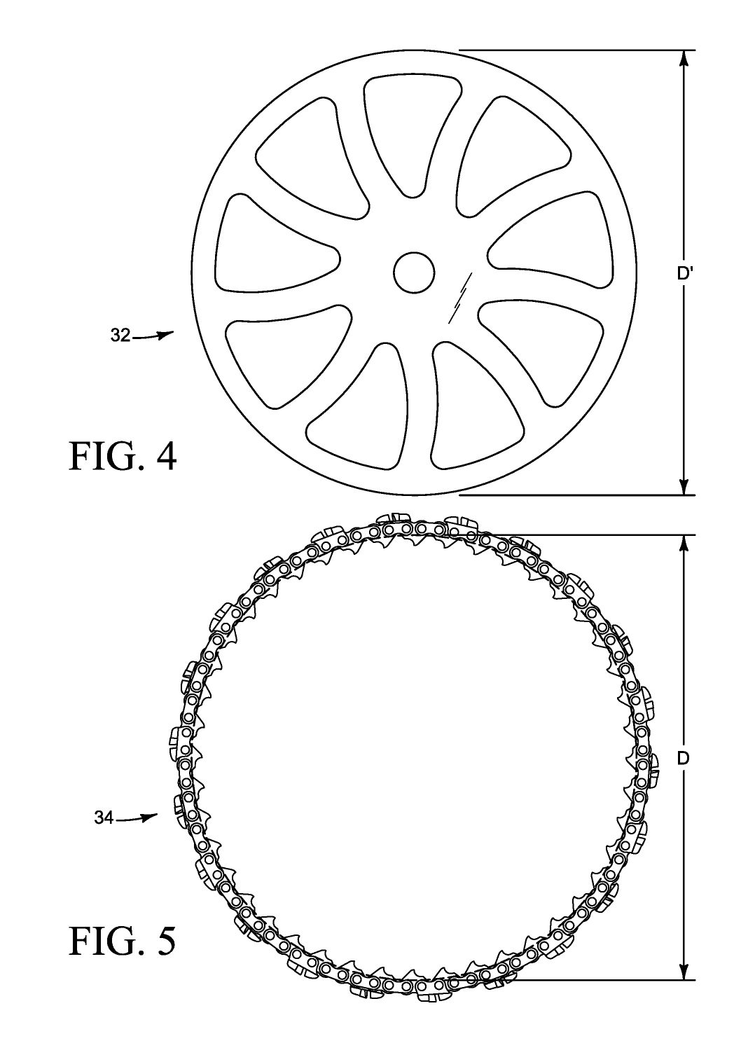

FIGS. 4 and 5 illustrate the core 32 and an endless chain assembly 34 of a preferred embodiment of the invention. The blade core has diameter D prime. The chain has inner diameter D. The diameters D prime and D ideally are virtually equivalent, or are such that when a chain 34 is stretched to place on the blade core 32, the difference in diameters D and D prime is minimal. This allows for a snug fit of the endless chain to the blade core. The drive links are located within the circumferential groove of the blade core.

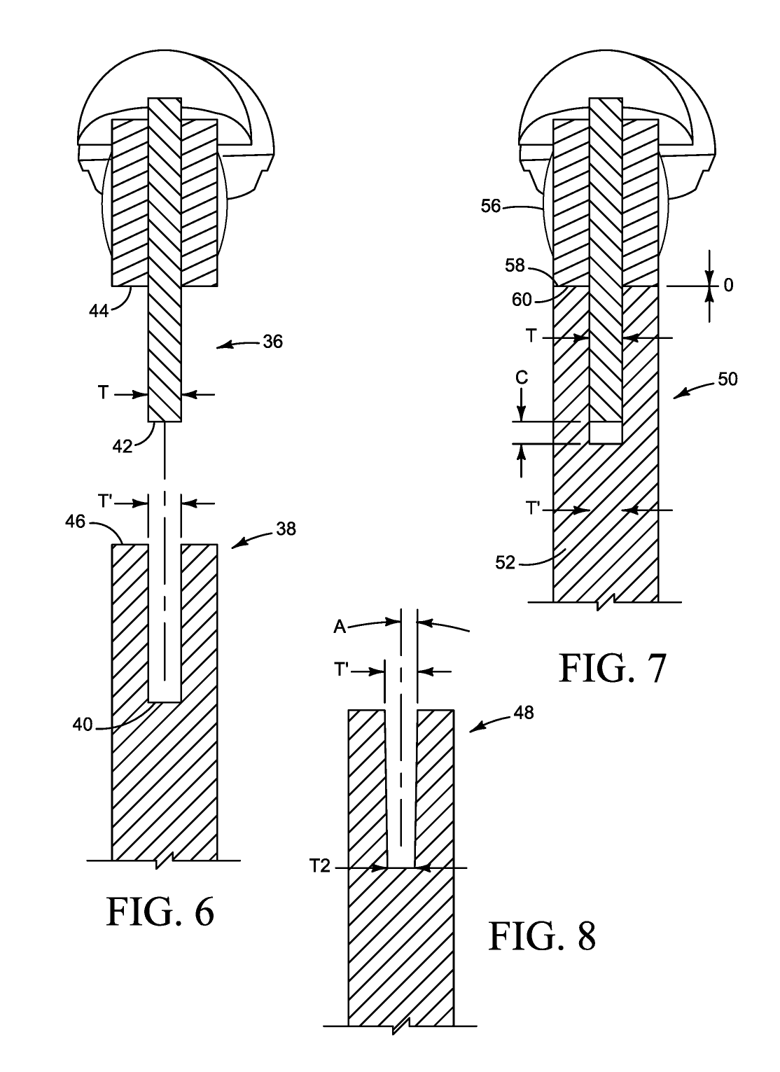

FIGS. 6-8 illustrate cross sectional views of embodiments of the cutting chain and blade core with circumferential groove. FIG. 6 illustrates a cross sectional view of a cutting chain 36 and a core having circumferential groove 38. The width of the circumferential groove in the blade core 38 is represented by distance T′. The circumferential groove extends into the blade core to an end point or base 40. The depth of the circumferential groove is preferably thought to be in close proximity to the length of the tang of the drive links of the cutting chain, such that any gap or tolerance between the base of the circumferential groove 40 and a tip 42 of a drive link is minimal, but without the tip 42 of the drive link and the bottom of the circumferential groove 40 in direct contact. In a preferred embodiment, the width of the drive link T is very close to the width of the circumferential groove T′. Ideally, when the chain is installed on the blade core, the chain has a general inner circumference approximately equivalent to the outer circumference of the blade core. When the chain is stretched, the chain is placed onto the circumference of the blade core, such that the drive links 42 are located within the circumferential groove of the blade core. The stretching of the chain can be performed in a multitude of ways known to one having skill in the art. In a preferred embodiment, the chain is a length with two ends. The chain is placed on the blade core and the two ends are pulled toward one another thus stretching the chain. The chain is stretched until the tie strap at each end of the chain are aligned such that a rivet can be placed through the two tie straps thus connecting the two ends of the chain to form an endless loop attached to (also called located on) said blade core.

In a preferred embodiment, the width of the drive link T is equivalent or very close to the width T′ of the circumferential groove. This tolerance should be low in order to maintain friction between the drive link 36 and the blade core 38 such that when the blade core and chain assembly is used to cut material, the chain does not spin freely but is instead held in place by the friction. In a preferred embodiment the width of the tie strap 44 or cutter is the same or approximately the same as the width of the rail 46 such that when the cutting chain and blade assembly is utilized, lateral movement of the chain is minimized by the equivalent width of the rails and the tie strap.

FIG. 7 illustrates the cutting chain assembly 36 and blade core 38 of FIG. 5 in an assembled position. As illustrated, the cutting chain assembly 56 is seated on the blade core 52 such that the drive link or tang of the drive link is located within the circumferential groove. The width of the drive link T as illustrated is very close to the width of the circumferential groove T′. The drive link extends into the circumferential groove to a point such that there is a small width C between the point or bottom of the drive link and the lower surface of the circumferential groove. The base of the tie strap 60 is illustrated in tight tolerance or even in contact with the outer circumference 58 of the blade core. This tight tolerance is illustrated by arrows showing minimal tolerance 0.

FIG. 8 illustrates the circumferential groove in a preferred embodiment. FIG. 8 illustrates the blade core 48 having a circumferential groove that is tapered such that the width of the groove at the outer circumference of the blade core T′ is greater than the width of the circumferential groove T2. This provides an angular groove at Angle A such that a drive link point is held in tighter tolerance with more friction toward the point of the drive link.

It is thought that the friction between the drive link and the inner surfaces of the circumferential groove hold the chain in place with minimal slippage. This way, when a cutting tip on the chain impacts a material, the chain does not freely spin around the blade, or the blade spin within the chain.

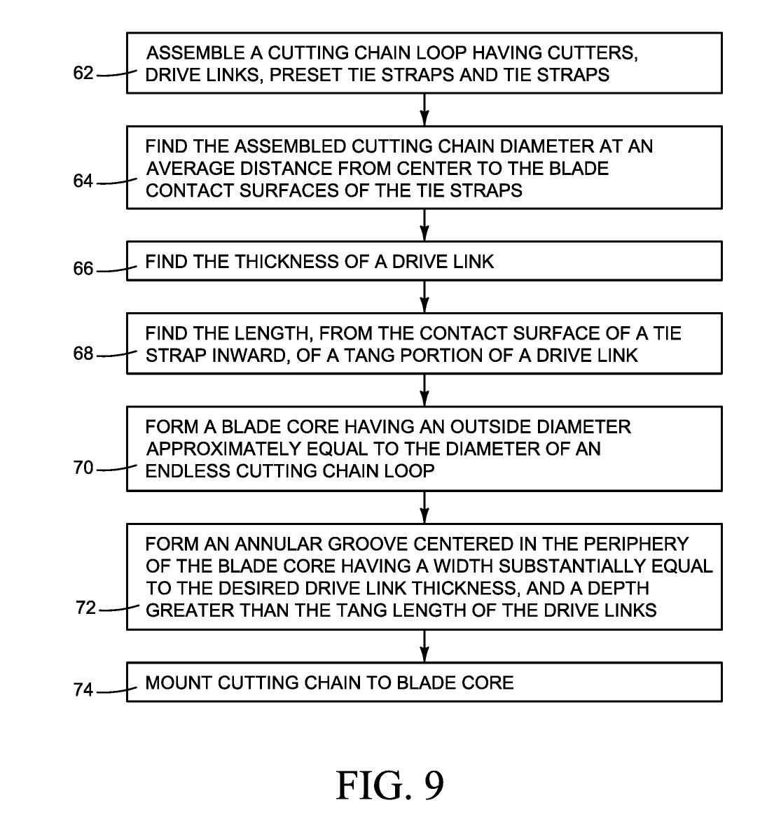

FIG. 9 illustrates a method of constructing an assembled cutting chain and blade apparatus according to an embodiment of the invention. A cutting chain and a circular core having an annular or circumferential groove are constructed 62, 70. The blade core is constructed such that the outer diameter of the blade core is approximately equal to the diameter of the chain formed in an endless loop. In a preferred embodiment, the chain is formed in an endless cutting chain loop after it has been stretched around the circumference of the blade core. The annular groove in the blade core is generally centered in the periphery of the blade core protruding inward from the circumference. The annular groove generally has a width approximate to the drive link thickness of the chain anticipated to be placed on the blade core. The depth of the groove is generally greater than the link of the drive link such that the tang and the bottom of the groove do not contact. This is thought to place additional stress on the tang thus leading to potential breakage of the tang. The width of the annular groove is calculated and constructed such that the tie strap thickness is generally wider than the groove width such that the tie straps rest upon the circumference of the blade annular groove as depicted in FIGS. 6 and 7. The chain is stretched such that chain is placed into the annular groove, and when the tension is released from the stretching of the chain, the chain reflexes such that the chain is taught around the blade core and the drive links of the chain are located in the annular groove.

While certain exemplary embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. A circular core for a saw blade for use with a chain, said circular core comprising:
a circular disc like core body having an outer circumference and a width, wherein said core body comprises a central arbor substantially at the center of said core body and configured to provide an axis of rotation for a circular saw, wherein said core body comprises a first side and a second side separated by said width of said core body, wherein said core body comprises a circumferential groove extending inward from said circumference of said core body between said first side and said second side to a floor wherein said circumference of said core body comprises two rails defining said circumferential groove.

2. The circular core for a saw blade for use with a chain of claim 1, wherein said circular core comprises an endless chain positioned on said circumference of said core body, wherein said chain comprises drive links positioned within said circumferential groove.

3. The circular core for a saw blade for use with a chain of claim 2, wherein said circumferential groove comprises a width, wherein said width is approximate to said width of said drive links positioned within said circumferential groove.

4. The circular core for a saw blade for use with a chain of claim 3, wherein said circumferential groove is within +0.05 mm -0 in width of said drive links of said chain positioned within said groove.

5. The circular core for a saw blade for use with a chain of claim 3, wherein said chain comprises a series of chain links, wherein said chain links comprise a width, wherein said chain is positioned on said core such that said links are in contact with said circumference of said blade core when said blade core is not rotating at a high speed.

6. The circular core for a saw blade for use with a chain of claim 3, wherein said circular core is attached to a circular saw.

7. The circular core for a saw blade for use with a chain of claim 3, wherein said groove comprises a floor, wherein said floor of said groove is located between said arbor and said circumference of said groove and is between said first side and said second side of said core body, wherein said drive link extends into said core to a point proximate to but not in contact with said floor of said groove.

8. The circular core for a saw blade for use with a chain of claim 3, wherein said endless chain is generally taught when on said circular core.

9. The circular core for saw blade for use with a chain of claim 1, wherein said circumferential groove is wider at said circumference of said circular core than at said floor of said circumferential groove.

10. The circular saw blade assembly of claim 1, wherein said circumference does not include sprocket teeth configured for the placement within link of a chain.

11. The circular saw blade assembly of claim 2, wherein said endless chain comprises alternating tie strap-cutter and tie strap-tie strap sections wherein said width of said rails defining said circumferential groove are approximately the same width as an individual tie straps or cutter of said tie straps and said cutters comprising said tie strap-cutter and said tie strap-tie strap sections.

12. A circular core and endless chain assembly with a circular saw, said circular core assembly comprising:
a circular disc like core body having an outer circumference and a width, wherein said core body comprises a central arbor substantially at the center of said core body and configured to provide an axis of rotation for a circular saw, a circular disc like core body having an outer circumference and a width, wherein said core body comprises a central arbor substantially at the center of said core body and configured to provide an axis of rotation for a circular saw, wherein said core body comprises a first side and a second side separated by said width of said core body, wherein said core body comprises a circumferential groove extending inward from said circumference of said core body between said first side and said second side to a floor; and
an endless chain positioned on said core body, wherein said chain comprises drive links positioned within said circumferential groove.

13. The circular core and endless chain assembly of claim 12, wherein said groove is wider at said circumference of said circular core than at said floor of said groove.

14. The circular core and endless chain assembly of claim 12, wherein said circumferential groove comprises a width, wherein said width is approximate to said width of said drive links positioned within said circumferential groove.

15. The circular core for a saw blade for use with a chain of claim 14, wherein said circumferential groove is within +0.05 mm -0 in width of said drive links of said chain positioned within said groove.

16. The circular saw blade assembly of claim 12, wherein said circumference does not include sprocket teeth configured for the placement within link of a chain.

17. A method of using a circular blade core in a circular saw, wherein said method comprises the following steps:
the step of attaching a blade core comprising a circular disc like core body having an outer circumference and a width between a first side and a second side, wherein said core body comprises a central arbor substantially at the center of said disc and configured to provide an axis of rotation for a circular saw, wherein said circular disc comprises a first side and a second side separated by said width of said circular disc, wherein said core body comprises a circumferential groove extending inward from said circumference of said core body between said first side and said second side to a floor;
the step of attaching a chain comprising cutting elements and drive links to said blade core by stretching said chain using tension to allow for said chain to be placed around said circumference of said blade core such that said drive links are positioned within said circumferential groove and releasing said tension on said chain; and
the step of using said saw to rotate said blade core and chain and cutting material with said cutting elements of said chain by contacting said rotating blade core and chain with said material.

18. The method of claim 17, wherein said saw is used to cut wood, metal, concrete and various hard materials.

19. The method of claim 18 wherein said saw is used in emergency rescue for cutting into a building, vehicle, train, cars or aircraft.

20. The method of claim 17 wherein said method further comprises the step of replacing said chain, wherein said chain is replaced by removing a rivet connecting two links of said chain, wherein said chain is removed from said circular core, wherein a second chain having two ends is attached to said core by stretching said second chain having two ends around said circular core such that drive links of said second chain are located within said circumferential groove and attaching said two ends of said chain using a rivet to form an endless chain loop around said circular core.
